(19) United States
(12) Patent Application Publication
(10) Pub. No.: US 2026/0163998 A1
(43) Pub. Date: Jun. 11, 2026

(54) Systems and Methods for Adaptive Streaming for Real-Time Video Analytics (ASTRA)

(71) Applicant: The Trustees of Columbia University in the City of New York, New York, NY (US)

(72) Inventors: Mahshid GHASEMI DEHKORDI, New York, NY (US); Zoran Kostic, New York, NY (US); Gil Zussman, New York, NY (US); Javad Ghaderi, New York, NY (US)

(73) Assignee: The Trustees of Columbia University in the City of New York, New York, NY (US)

(21) Appl. No.: 19/179,836

(22) Filed: Apr. 15, 2025

Related U.S. Application Data
(60) Provisional application No. 63/633,989, filed on Apr. 15, 2024.

(51) Int. Cl. H04N 7/18; G06V 10/94; G06V 20/52; H04N 23/90

(52) U.S. Cl. CPC H04N 7/181; G06V 10/95; G06V 20/52; H04N 23/90

(57) ABSTRACT

Disclosed are implementations, including a method for real-time adaptive video analytics generation that includes receiving, at a processor-based device, video data from at least one remote video capture device, and determining, at the processor-based device, based on multiple portions of the video data received from the at least one video capture device, a particular video capture configuration, selected from a plurality of pre-determined video-capture configurations, that optimizes an adaptation objective function derived based on a machine learning detection accuracy score achieved using the particular video capture configuration and on a processing and networking latency score resulting from the particular video configuration. The method further includes adapting the at least one remote video capture device to transmit video data according to the determined particular video configuration for a particular period of time.

### CROSS-REFERENCE TO RELATED APPLICATIONS

This application claims priority to, and the benefit of, U.S. Provisional Application No. 63/633,989, entitled “Systems and Methods for Adaptive Streaming for Real-Time Video Analytics (ASTRA)” and filed Apr. 15, 2024, the content of which is incorporated herein by reference in its entirety.

### STATEMENT REGARDING FEDERALLY SPONSORED RESEARCH

This invention was made with government support under grants 2038984 and 1827923 awarded by the National Science Foundation (NSF), and under grant W911NF1910379 awarded by the Army Research Office (ARO). The government has certain rights in the invention.

### BACKGROUND

Real-time video analytics is crucial for smart city applications and cloud-connected vehicle control. In order to improve analytics accuracy, it is desirable to process the video at the highest resolution and frame rate. However, due to limited compute, memory, and network resources, streaming and processing video at the highest resolution and frame rate from all the cameras is not feasible and adversely affects the analytics latency.

### SUMMARY

Described herein is a proposed framework for efficiently executing online adaptation processes for large-scale video analytics optimization. The proposed framework, referred to as ASTRA ((Adaptive STreaming for Real-time video Analytics) was uniquely evaluated in a real-world environment in the COSMOS testbed and in Google Cloud (that can emulate larger deployment), using an extensive dataset of videos collected from the testbed. It was shown that the framework maintains robust performance in dynamic environments, achieving over 90% reliability in satisfying accuracy and latency requirements. The proposed framework incurs around 2% average GPU utilization overhead per camera compared to offline optimal. In some embodiments, the proposed framework can leverage multi-camera video stream correlations similar to single stream configuration performance correlations, examine adaptive time window lengths to address sudden content or network fluctuations, and/or extend ASTRA for geo-distributed edge/cloud analytics with dynamic resource allocation and more configuration parameters.

In some variations, a method for real-time adaptive video analytics generation is disclosed that includes receiving, at a processor-based device, video data from at least one remote video capture device, and determining, at the processor-based device, based on multiple portions of the video data received from the at least one video capture device, a particular video capture configuration, selected from a plurality of pre-determined video-capture configurations, that optimizes an adaptation objective function derived based on a machine learning detection accuracy score achieved using the particular video capture configuration and on a processing and networking latency score resulting from the particular video configuration. The method additionally includes adapting the at least one remote video capture device to transmit video data according to the determined particular video configuration for a particular period of time.

In some variations, a surveillance system with real-time adaptive video analytics generation is provided that includes at least one remote video capture device, and at least one processor-based device in communication with the at least one remote video capture device. The at least one processor-based device is configured to receive video data from at least one video remote capture device, and determine based on multiple portions of the video data received from the at least one remote video capture device, a particular video capture configuration, selected from a plurality of pre-determined video-capture configurations, that optimizes an adaptation objective function derived based on a machine learning detection accuracy score achieved using the particular video capture configuration and on a processing and networking latency score resulting from the particular video configuration. The at least one processor-based device is configured to adapt the at least one remote video capture device to transmit video data according to the determined particular video configuration for a particular period of time.

In some variations, a non-transitory computer readable media is provided that includes computer instructions executable on a processor-based device to receive video data from at least one remote video capture device, and determine based on multiple portions of the video data received from the at least one video capture device, a particular video capture configuration, selected from a plurality of pre-determined video-capture configurations, that optimizes an adaptation objective function derived based on a machine learning detection accuracy score achieved using the particular video capture configuration and on a processing and networking latency score resulting from the particular video configuration. The computer instructions further cause the processor-based device to adapt the at least one remote video capture device to transmit video data according to the determined particular video configuration for a particular period of time.

Embodiments of the method, system, and the computer readable media may include at least one or more of the features described in the present disclosure.

Other features and advantages of the invention are apparent from the following description, and from the claims.

### BRIEF DESCRIPTION OF THE DRAWINGS

These and other aspects will now be described in detail with reference to the following drawings.

FIG. 1 is a diagram illustrating an overview of an example ASTRA framework.

FIG. 2 is a diagram illustrating an example of an allocation of adaptation periods for three cameras in two successive time windows under the ASTRA framework.

FIG. 3 is a diagram of an example modular adaptation implementation that may be used with the ASTRA framework.

FIG. 4 is a flowchart of an example procedure for real-time adaptive video analytics generation.

Like reference symbols in the various drawings indicate like elements.

### DESCRIPTION

Described herein is a proposed low-overheard framework, referred to as ASTRA (Adaptive STreaming for Real-time video Analytics), configured for online adaptation of video analytics in multi-camera/edge-cloud settings. The proposed framework can execute online adaptation algorithms, rooted in reinforcement learning, as a black box. The framework includes a procedure (GP-UCB-C) that accelerates adaptation by leveraging configuration correlations. The proposed framework was deployed in the NSF COSMOS testbed and had its performance uniquely assessed in real-time using street-level cameras. The framework was evaluated with up to eight emulated cameras by streaming a comprehensive video dataset under real-world network conditions. The results indicate that when integrated with the proposed GP-UCB-C algorithm, the ASTRA framework ensures system reliability (i.e., probability of meeting the accuracy and latency requirements) of more than 90% while maintaining performance within less than 10% deviation from the offline optimal performance with average GPU utilization overhead of around 2% per camera. The primary goal of online adaptation is to maximize performance with constrained resources. Therefore, it is important that the adaptation system incurs minimal overhead in executing the online adaptation algorithms, is flexible enough to accommodate different types of applications (e.g., latency-sensitive and accuracy-sensitive) and DNN models, and, given the rapid evolution of online adaptation processes, allows for easy integration of new processes/algorithms, requiring minimal changes.

The proposed framework can be used to analyze large volume of video data, collected potentially from a vast number of video cameras, to determine, for example, security data for a geographic area covered by the video cameras. The proposed framework leverages memory and GPU management techniques (in terms of timing and capacity) to derive the security data (security analytics). When used to determine security data, the proposed framework is configured to perform real-time detection of indicators of security threats, including intrusion, altercation, firearms, bullying, and other anomalies, and is capable of automatically searching through hours of recorded videos for a specific incident in a short period of time (minutes or less). The proposed framework can also be used in other applications and use cases requiring real-time video analytics, e.g., in situations requiring real-time context assessment for detecting warning signs and anomalies (for example, situations involving traffic and transportations, anomalies occurring in fast-moving assembly lines, etc.)

Real-time processing of video streams using DNNs is computationally demanding. For instance, the execution of a conventional object detection model on a single video stream with 8322 resolution and 30 fps can consume most of the processing capacity of a T4 GPU. In such a case, processing additional 30 fps 8322 streams leads to increased inference latency unless the resolution or frame rate of at least one of the video streams or the DNN complexity is reduced. Depending on the density level and movements in the monitored scene, different resolutions, frame rates, and DNN complexities are required to achieve sufficient accuracy. For example, for cameras viewing urban streets, when vehicles are moving slowly—e.g., at a red traffic light or during heavy traffic—the frame rate can be reduced without losing accuracy. Similarly, when the pedestrians' density is low, or they are close to the camera, the resolution can be reduced without affecting the accuracy. Therefore, optimizing parameters such as resolution and frame rate when feasible, can significantly save on bandwidth and computational power. The proposed framework focuses on dynamically identifying video streams' configuration characteristics, such as resolutions and frame rates, that maximize the overall performance—a function of accuracy and end-to-end latency—under limited computation and network capacity while meeting application-specific constraints on accuracy and end-to-end latency. A specific combination of resolution and frame rate for a stream (and optionally other parameters and characteristics of a video stream) is referred to as a configuration.

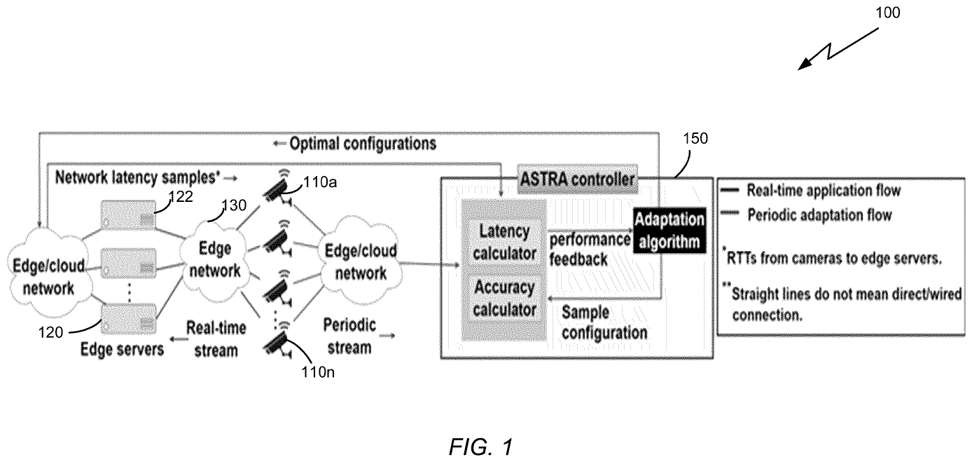

Thus, with reference to FIG. 1, a diagram illustrating an overview of an ASTRA framework 100 is provided. The framework (system) 100 includes a multi-camera setup, comprising cameras 110a-n connected to edge servers (such as edge servers 120 and 122) via communication networks such edge network 130 (such networks may be wired networks, for example, packet-based networks, or wireless networks). The ASTRA framework 100 includes an ASTRA controller 150 that is adapted to update the configuration of the framework (system) 100 periodically in response to changes in the environment.

More particularly, consider a setting where real-time video streams from several cameras, such as the cameras 110a-n depicted in FIG. 1, are transmitted to edge servers to derive video analytics (such as object detection) using machine learning models (DNN models, or other types of machine learning models and architectures). The key performance metrics of such a system are accuracy and (end-to-end) latency. Accuracy and latency are time-varying, unknown functions of system's configurations (e.g., resolution and frame rate of cameras). The characteristics of these functions depend on dynamic parameters such as video content, DNN model complexity, encoding scheme, network conditions, and the computational resources available.

The objective is to dynamically find the configurations that maximize a weighted sum (or any other function) of accuracy and latency subject to constraints on maximum latency and minimum accuracy. The unpredictable and dynamic nature of the problem limits the effectiveness of empirical modeling and deterministic optimization in identifying near-optimal configurations. Decision making in such dynamic unknown settings falls within the paradigm of Reinforcement Learning (RL), which can use, for example, Multi-Armed Bandit (MAB) processes. At each iteration t of an MAB process, for each camera, one configuration xₜ is sampled. Here, xₜ∈X, where X is a discrete set comprising a finite number of supported resolutions and frame rates. Then, xₜ's achieved accuracy, Aₜ(xₜ), and latency, Lₜ(xₜ) on a short slot (t seconds) of a camera's video stream, referred to as a video chunk—denoted by sₜ—is evaluated. The results up to iteration t are used to decide on the subsequent configuration xₜ₊₁ to be evaluated. This process can be executed indefinitely or terminated upon identification of a near-optimal configuration. Such processes or algorithms are referred to as online adaptation processes/algorithms.

Accuracy, Aₜ(xₜ) can be calculated by comparing the obtained video analytics results (such as, for example, object detection results, e.g., bounding boxes and labels) using configuration xₜ on video chunk sₜ against the ground truth. In some embodiments, the detection F1-score (harmonic mean of precision and recall) can be used. The detection F1-score is computed by verifying if a bounding box shares the same label and has sufficient spatial overlap with the associated ground truth. To account for the impact of frame rate on the accuracy, the location of objects from the previous sampled frame can be used for a frame that is not sampled by the configuration. Latency, Lₜ(xₜ) is defined as the sum of the encoding latency of sₜ by the camera, the network latency to transfer sₜ from the camera to the server, the decoding latency of sₜ on the server, and the inference latency to run video analytics on it with configuration xₜ.

The precise ground truth required for calculating Aₜ(xₜ) can generally be obtained through manual annotation, but is infeasible in real-time. Moreover, replacing the manually obtained ground truth with analytical approximation or confidence scores generated by the DNN introduces uncertain errors in accuracy measurements. Imprecise accuracy measurement can lead to choosing configurations far from optimal. It is apparent that the highest accuracy that the DNN can achieve is under the most resource-intensive configuration, e.g., the highest resolution and frame rate. This configuration is referred to as the golden configuration. Consequently, the DNN's accuracy under the golden configuration can be considered as a benchmark for assessing its accuracy when using less resource-intensive configurations. Therefore, ASTRA uses a proxy ground truth defined as the output of a DNN under golden configuration. This proxy ground truth is referred to as the proxy.

Each iteration of an online adaptation process incurs substantial overhead. In particular, generating proxies (by definition) and sequentially switching between configurations and video chunks incur network, computational, and temporal overhead. Thus, to enable efficient execution of such online adaptation processes, these overheads should be mitigated An effective adaptation framework should ensure that the system uses a near-optimal configuration majority of the time while it incurs low overhead. To facilitate these, the adaptation framework should identify a near-optimal configuration within a limited time. However, due to unpredictable variations in network condition and video content, the optimal configuration significantly changes over time. Consequently, the adaptation needs to be performed repeatedly.

To account for unknown dynamics and avoid long adaptation time, two architectural choices are made in the ASTRA framework: periodic adaptation and round-robin adaptation. The ASTRA performs adaptation periodically. The adaptation frequency depends on environmental volatility. One adaptation cycle is referred to as a time window. Aₜ the onset of each time window, the ASTRA framework resumes the process until a near-optimal configuration is found by the adaptation process. Then, the system's configuration is updated accordingly and is used for the remaining of the time window. To keep the adaptation overhead low, the adaptation period should remain small relative to the time window length (e.g., less than 10%).

As noted, another architectural choice is the use of a round-robin camera adaptation in which adaptations are executed for individual cameras sequentially, adopting a round-robin approach. This strategy prevents (inhibits) the configuration space from growing exponentially with the addition of more cameras. Since the cameras might share network and computational resources, this design decision could yield suboptimal results. Further, global adaptation for all cameras aggravates the issue due to the rising adaptation time with the exponential increase in the number of configurations. An extended adaptation time will result in higher overhead and an overall decline in average performance. A round-robin approach, on the other hand, facilitates distributed adaptation for geo-distributed cameras. However, depending on the resources available for adaptation, this approach can be adjusted to accommodate the adaptation of a batch of cameras simultaneously as long as the adaptation time of each batch remains small relative to the time window's length.

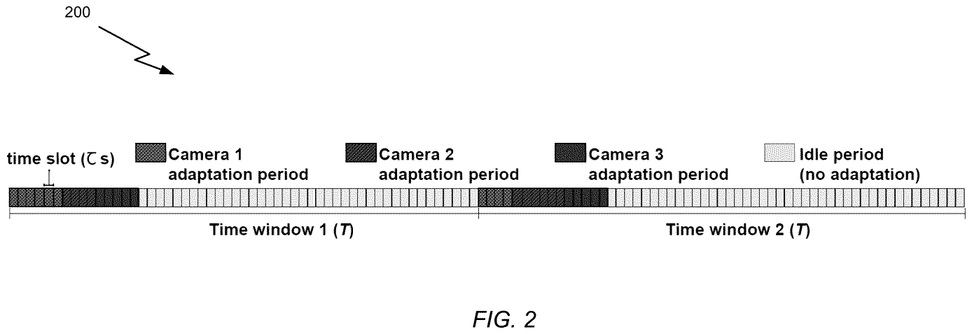

FIG. 2, is a diagram 200 illustrating an example of an allocation of adaptation periods for three cameras in two successive time windows under the ASTRA framework. As illustrated, time is divided into small slots of length t (e.g., 0.2 s) which is equal to the length of a video chunk. Each video chunk or time slot corresponds to one iteration of the online adaptation algorithm. The adaptation cycle (time window) includes T slots. The segment of the camera i's video stream corresponding to its adaptation period is referred to as the adaptation video segment. The adaptation video segment, which should be much shorter than a single time window, is used to identify a (near-) optimal configuration for that specific time window. The total adaptation period for all cameras should not exceed the duration of a time window.

ASTRA's adaptation process includes several simultaneous tasks including real-time video stream chunkification, video chunk decoding, proxy generation, F1-score calculation, latency measurement, and iterative online adaptation process. To ensure low overhead and fast adaptation, these tasks should be executed smoothly in parallel, with minimal idle time for each one. However, the main challenge in doing so is that these tasks are (i) interdependent and (ii) have very different computational complexities. For example, F1-score calculation requires proxies and detection output of sampled configuration. Meanwhile, the adaptation algorithm requires the achieved latency and accuracy to select the subsequent configuration. Moreover, proxy generation is much more computationally expensive than video stream chunkification, which, in turn, incurs a higher computational cost than F1-score calculation and the adaptation process/algorithm.

Additionally, the architecture should be designed to facilitate easy updates to different components from latency calculation to the online adaptation algorithm. To address these challenges, ASTRA's architecture employs two key strategies: (i) a modular design for enhanced flexibility, and (ii) asynchronous programming for efficient operation. Under the modular design approach, the ASTRA architecture may be subdivided into, for example, four main modules: analytics executor, accuracy calculator, latency calculator, and configuration adaptor. These modules and their communications are designed to support edge/cloud-distributed deployment, making large-scale deployments feasible. Specifically, each module can be deployed on an individual edge/cloud server. Experiment results indicate that accuracy calculator, latency calculator, and the configuration adaptor are lightweight and incur low GPU utilization. Therefore, exclusive server allocation for these modules is not mandatory and they can be effectively deployed in shared servers.

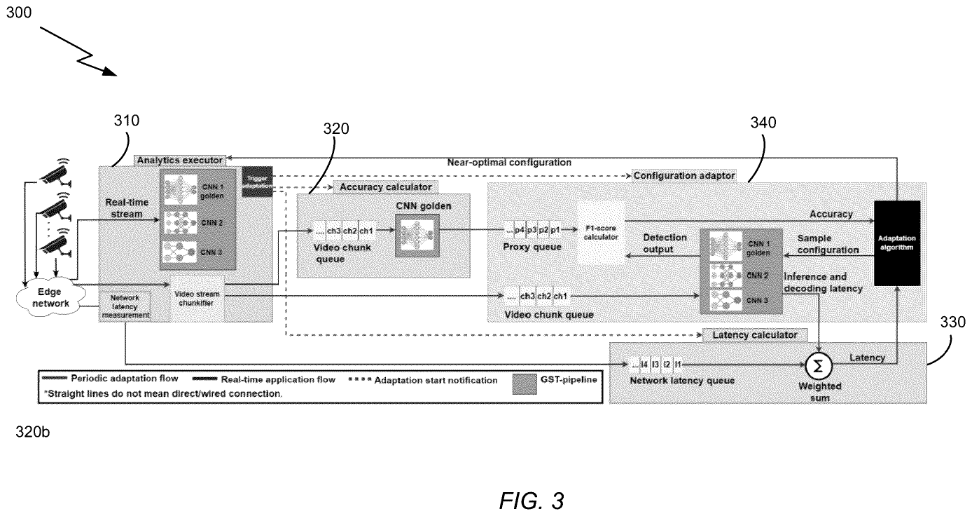

FIG. 3 is a diagram of an example modular adaptation implementation 300 that may be used in the ASTRA framework. The modular adaptation implementations 300 includes, for example an analytics executor 310, an accuracy calculator 320, a latency calculator 330, and a configuration adaptor 340.

The analytics executor 310 executes real-time object detection on video streams from the connected cameras using DNN models. During adaptation the analytics executors is configured to performs four main tasks. The first such task is to periodically trigger the adaptation for each connected camera. This ensures adaptation cycles align precisely with the defined time window, eliminating the need for accurate server time synchronization which is challenging. The second task splits the video stream with golden configuration to video chunks and sends them to the accuracy calculator and configuration adaptor modules upon creation. The third task measures (e.g., frequently) the network latency associated with video chunks and forwards them to the latency calculator module immediately upon measurement (network latency measurements are discussed in greater detail below). The fourth example task the analytics executor 310 performed is to adjust, at the end of each camera's adaptation period, the configuration of the video stream and the corresponding DNN in response to the output of the adaptation algorithm.

The configuration adaptor 340 also performs four main tasks during adaptation. Particularly, the adaptor 340 runs the abstract online adaptation process/algorithm as a black box. The adaptor 340 also iteratively runs the object detection DNNs on video chunks with the selected configurations by the adaptation algorithm. Another task performed by the configuration adaptor 340 is to measure the decoding and inference latency corresponding to the select configurations at each iteration. The adaptor 340 also computes the achieved accuracy (F1-score) by comparing the detection output of a selected configuration against the corresponding proxy. The achieved accuracy and end-to-end latency (calculated by latency calculator 330) are used to determine the next configuration to be sampled. Once adaptation is completed, it sends the obtained optimal (or near-optimal) configuration to the corresponding analytics executor 310, which subsequently updates the configuration of the video stream and the corresponding DNN accordingly.

With continued reference to FIG. 3, the accuracy calculator 320 is configured to generate corresponding proxies to video chunks used to determine the achieved accuracy of the chosen configurations at each iteration. The F1-score calculator component is intentionally placed in the configuration adaptor module to reduce the communication overhead among the modules that might be deployed on different servers. Specifically, if the F1-score calculator was inside the accuracy calculator module, there would be a need for more data exchange. The detection output had to be transmitted from the configuration adaptor module to the accuracy calculator module, and the obtained F1-score had to be sent back to the configuration adaptor module. As will become apparent below, even minor delays, when recurrent, can impact the overall performance of the architecture. The latency calculator 330 depicted in FIG. 3 derives the end-to-end latency at each iteration, which, in some example embodiments, is a sum of the decoding and inference latency of the sampled configuration, and the network latency associated with each video chunk measured by the analytics executor.

The architecture depicted in FIG. 3 (and also in FIG. 1) should also manage the differences in computational and time requirements among concurrent adaptation tasks to reduce their waiting (idle) time and ensure efficient resource utilization. In this regard, the ASTRA framework architecture executes the concurrent adaptation tasks asynchronously using techniques such as futures and promises. Leveraging asynchronous programming, these tasks can operate seamlessly without being bottlenecked by the slower tasks. For example, by employing futures and promises techniques, ASTRA handles the results of those tasks that are not immediately available. A future represents a result of an operation that is yet to be computed, such as proxies, video chunks, sample configurations, and latency values. A promise is the corresponding operation through which the value of a future is set once the result is available. Additionally, queuing can be utilized to help orchestrate, schedule, and decouple the asynchronous tasks.

In various embodiments, the adaptation process is initiated when the analytics executor sends a start notification to the accuracy calculator 320, the latency calculator 330, and the configuration adaptor 340 to trigger adaptation. Upon initiation of the adaptation process, the analytics executor starts streaming the encoded video with the golden configuration from the camera, splitting it into small chunks as the stream arrives and forwards them to accuracy calculator and configuration adaptor modules as they are generated. It is important to note that to avoid idle times for other modules and their sub-components, the video chunkification and forwarding process is done in an online manner without having to store the whole adaptation video segment first. The created chunks are stored in a first-in-first-out (FIFO) queue in the accuracy calculator and configuration adaptor modules.

In the accuracy calculator 320, the chunks are processed with the golden configuration sequentially, and the generated proxies are forwarded to the configuration adaptor upon creation. Similar to video chunks, the proxies are also stored in an FIFO queue. In the configuration adaptor module, each video chunk corresponds to a single iteration of the algorithm. Aₜ iteration t, the adaptation algorithm selects a sample configuration xₜ. The configuration adaptor 340 retrieves a video chunk from its video chunks queue and applies the object detection model with configuration xₜ on it. This process yields two critical observations: (i) xₜ's accuracy relative to the corresponding proxy read from the proxy queue, and (ii) xₜ's latency computed by the latency calculator 330. Based on these quantities, the configuration for the next iteration xₜ₊₁ is determined by the adaptation process. This process continues until the online adaptation algorithm stops with a near-optimal configuration, which is then communicated to the analytics executor 310. The analytics executor 310 then adjusts the configuration of the video stream and the DNN accordingly.

Measuring network latency with sufficient precision with no programmable computational unit on the camera side presents some challenges. Network latency is the time that it takes a video chunk with a specified length t and configuration to be delivered from the camera to the analytics executor. To measure this latency reasonably accurately, every t seconds the analytics executor 310 may be configured to request a video stream with a different configuration from the cameras. This, in turn, requires a new connection to be established. Experimentation results showed that this incurs a delay of up to hundreds of milliseconds, depending on the camera's hardware. Therefore, even for ten iterations, this can incur up to a few seconds of cumulative start-up delay that increases the adaptation time. Another challenge is that typical traffic cameras use NTP (Network Time Protocol) to record time stamps. However, experimentational measurements show that NTP synchronization, especially in asymmetric routes, leads to time discrepancies of up to a hundred milliseconds. As the network latency of each chunk usually does not exceed a few hundred milliseconds, NTP time stamps are not sufficient for precise measurement. Aa further challenge is that cameras' compression rates determines the size of encoded video chunks. A camera's compression rate depends on the video content and network condition, and so does the video chunk size. Due to the absence of a programmable computational unit in the cameras, size of video chunks is unknown to the latency calculator 330. Therefore, it cannot accurately measure the network latency for each video chunk in real-time. Due to the above challenges, in example implementations of the ASTRA framework the network latency measurement component estimates network latency by sending periodic ping requests to the camera. Particularly, the network latency measurement measures RTT from cameras to the edge server several times during the time that one chunk of video is transmitted, computes the average RTT/2, and sends the results to the latency calculator 330. However, the ASTRA framework's modular design allows for the substitution of the network latency measurement component with alternative approaches, particularly in a setting with more advanced cameras equipped with processors that can be programmed to communicate the details of encoding and accurate time stamps in run-time.

A noted above, consecutive performance measurement on small video chunks requires the following: (i) transmitting video stream encoded in golden configuration for generating proxies, (ii) splitting the encoded video streams into short video chunks (e.g., 0.2 s) without (or with minimal) buffering, (iii) transferring the video chunks to configuration adaptor and accuracy calculator modules, (iv) decoding the video chunks and apply two DNNs—one for the chosen configuration and one for the proxy—on them. Switching between configurations and video chunks at each time slot must happen seamlessly to avoid extra delay overhead.

To enable low-latency switching, it is important to understand switching inherent delays and overheads. Therefore, a thorough profiling of the run-time computational and memory overhead of the operations was conducted. The results of the profiling reveal several overhead components/factors contributing to switching delay.

One such component is pre-processing overheads. Prior to input into the object detection model, the video chunks must be decoded and converted according to the selected configuration. Depending on the video codec, such pre-processing with standard tools such as FFmpeg—without further optimization-incurs up to tens of milliseconds delay per frame. For each video chunk (0.2 s, equivalent to 6 frames at 30 fps) this delay can exceed a hundred milliseconds. Another factor contributing to the delay is the pipeline reconfiguration overheads. Processing video chunks with different resolutions and frame rates requires re-compiling the pipeline elements including the decoder, pre-processor, and/or DNN model. This re-compilation incurs a delay that, without further optimization, could extend to hundreds of milliseconds.

Data transfer overheads represent another source of delays. Executing DNNs on GPU necessitates frequent transfer of decoded video frames to GPU memory and subsequently transfer of the obtained bounding box information back to the CPU for F1-score calculation. These data transfers incur delays of up to tens of milliseconds per chunk, especially when invoked frequently and when the GPU is busy with processing frames. Another source of delay is the model loading and initialization overheads. Loading a DNN model into memory incurs I/O and initialization delays (up to a few seconds). Moreover, different configurations necessitate different models or model versions, making this overhead recurrent.

A further source of delay involves the memory allocation and deallocation overheads. Processing a sequence of video chunks with different configurations requires frequent memory allocation/deallocation that introduces associated delays. Another delay source involves cache inefficiencies, namely, switching between video chunks and configurations can disturb cache continuity, resulting in increased cache misses. Given that GPU performance is highly contingent on memory hierarchy, cache misses can lead to inefficiencies in memory access that incur extra delays. Synchronization overheads also add to latency issues. Ensuring different components of the pipeline (such as decoding, pre-processing, and inference) work in synchronization can introduce unpredictable waiting times. Overhead due to interrupts and system calls is a further source of delay. Here, frequent system calls or handling interrupts, especially in a multitasking environment, can introduce unpredictable delays.

The above-described delays, even though small—mostly ranging from tens of milliseconds to hundreds of milliseconds—could nevertheless severely impact large-scale online adaptation. Consider an adaptation algorithm that can determine a near-optimal configuration in only ten iterations. With a switching delay of even a few hundred milliseconds per iteration, this totals a few seconds solely for switching, exclusive of the time needed for processing and generating the chunks and proxies. Optimizing these delays often requires a combination of hardware and software strategies. Hardware acceleration (e.g., using dedicated video decoding chips and GPUs), efficient memory management techniques, and asynchronous programming are some of the common methods employed to mitigate these inherent overheads.

To mitigate the various network delays discussed above, various ASTRA-based strategies have been developed to handle the switching overhead. Standard high-level frameworks used for video analytics, e.g., based on PyTorch and OpenCV, are limited in mitigating the overheads discussed above. Implementing an end-to-end video analytics pipeline by integrating various high-level libraries for different tasks (e.g., parsing, decoding, inference), causes inefficiencies through data conversion, frequent memory copying, and synchronization, and, therefore, does not offer the low-level control and optimization needed to mitigate the switching overheads. Therefore, a GStreamer, which is a low-level multimedia framework in C, was used to develop a video analytics pipeline with low latency switching capability (this pipeline is referred to as GST-pipeline, examples of which are illustrated in FIG. 3). GST-pipeline reduces switching latency of hundreds of milliseconds to 10-20 milliseconds.

The main features of GST-pipeline that allow low-latency switching include efficient buffer management. Particularly, since video chunks are small, there is no need to have large buffers in between the successive elements in the pipeline (e.g., parser, decoder, and inference). Therefore, the buffer sizes can be used to reduce one frame to eliminate the buffering delay. Additionally, the GST-pipeline incorporate zero-copy memory. Such zero-copy memory, provided by CUDA, allows the CPU to directly access the GPU's memory, eliminating the need for frequent copying of data such as video frames and output bounding boxes. This approach can significantly reduce the overhead in data transfer, especially for small or frequently accessed data.

Another approach for mitigating switching overhead is through dynamic pipeline reconfiguration. Particularly, GST-pipeline is implemented to support dynamic pipeline reconfiguration. This allows for changing the pipeline configuration parameters and input video chunks during run-time without being recompiled and restarted. This reduces the switching delay from hundreds of milliseconds to around ten milliseconds. In order to do this, several possible techniques were used to develop responsive dynamic pipelines:
1) Dynamic memory allocation: Dynamic memory allocation is used to manage GST-pipeline resources including pipeline configuration and state, input video chunk, and detection output. Dynamic memory allocation, as opposed to static memory allocation, allows GST-pipeline to allocate, resize, and deallocate memory at run-time. This allows the pipeline to modify resolution, frame rate, version of the DNN model, input video chunk, and, where the output bounding boxes are stored in an online manner, to eliminate the need for transferring in between memories and re-compilation delay.
2) Pre-loading the DNN model into GPU memory: To eliminate the start-up delay associated with loading and initiating the DNN models, the supported versions of the DNN models are pre-loaded into GPU memory. When these DNN models (loaded in GPU) are idle, they incur zero computational overhead.
3) Asynchronous event-driven operations: To ensure that GST-pipeline parameters change on demand with minimal delay, the signals and callbacks technique was widely used. Signals serve as events that notify the pipeline of the need to change its parameters. Examples of such signals include the determination of the next sampled configuration, availability of the next video chunk, and completion of the current chunk's processing. These signals are linked to specific callback functions, which are triggered upon the emission of their associated signals. These callback functions are responsible for adjusting the pipeline's parameters at run-time.

Yet another switching overhead mitigation approach is the TensorRT integration approach. Under this approach, TensorRT is used to optimize the DNN models to achieve speed up in inference, reduction in GPU computation, and memory utilization on commonly-used NVIDIA GPUs. TensorRT optimizes DNN models using techniques such as layer fusion, tensor fusion, kernel autotuning, and quantization. For example, DNN, models typically have tensors representing weights and tensors, representing the bias terms. These tensors should be separated during the training and back-propagation. However, back-propagation is not needed during inference. Therefore, to save computation and memory overhead, TensorRT combines these tensors.

Beside an efficient architecture, in various embodiments, the online adaptation process also impacts the overall performance of the system. Specifically, the adaptation process has to identify near-optimal configurations within a small number of iterations to avoid prolonged adaptation time. The GP-UCB-C process/algorithm discussed below reduces, on average, the time required to perform the adaptation process discussed. As noted above, the objective is to find a configuration x for each camera that maximizes a weighted sum of accuracy A(x) and latency L(x) subject to constraints on maximum latency and minimum accuracy, e.g., the goal of the adaptation process is to find, in some embodiments:

$${max}_{x ∈ X} {c}_{a} A ( x ) - {C}_{l} L ( x ) \qquad ( P1 )$$

$$subject to α \leq A ( x ) , L ( x ) \leq β ,$$

where α and β are application-specific bounds on accuracy and latency, and cₗ≥0 and cₐ≥0 are weights associated with latency and accuracy.

The performance of different configurations in video analytics applications is highly correlated. For instance, in object detection, a configuration with a higher resolution should achieve higher accuracy. This suggests that observing the performance of one configuration can be leveraged to update our estimate of other configurations' performance, and therefore, accelerate the identification of a near-optimal configuration. Hence, problem (P1) can be seen as an instance of a Multi-Armed Bandit problem with correlated arms with arms being the configurations.

To account for the unknown correlation among different configurations, the Gaussian Process (GP) model is used. Specifically, A(x) and L(x), for x∈X can each be modeled as a sample from a GP. The UCB algorithm/process for iterative arm (configuration) selection can be used. However, the standard GP-UCB has been designed for unconstrained optimization. Thus, to solve (P1), a CONFIG algorithm/process is adopted that extends the standard GP-UCB process to constrained optimization as in (P1). However, similar to standard GP-UCB processing, CONFIG does not have any mechanism for terminating the process/algorithm after identifying a near-optimal configuration. To address this issue, the GP-UCB-C incorporates a stopping condition into CONFIG. Table 1, below, provides pseudocode implementation for the GP-UCB process with Constraints (GP-UCB-C):

```
Procedure 1: GP-UCB with Constraints (GP-UCB-C)
  1: Input: [symbol] 1 = χ, GP kernel function, α, β, cₐ, c_{b} ∈ R⁺.
  2: for t = 1, 2, 3 . . . , T do
  $3 : Choose {x}_{t} = arg max {c}_{a} {U}_{t}^{a} ( x ) = q {,}_{l} {L}_{t}^{l} ( x ) , where x ∈ {𝒜}_{t} .$
  4: Measure Aₜ(xₜ) and Lₜ(xt).
  5: Perform GP update.
    $6 : Update feasibility set {𝒜}_{t + 1} = \{ x ∈ X \vert α \leq {U}_{t + 1}^{a} ( x ) , {L}_{t + 1}^{l} ( x ) \leq β \} .$
  $7 : {h}_{t + 1} := arg max {c}_{a} {μ}_{t}^{a} ( x ) - {c}_{l} {μ}_{t}^{l} ( x ) , where x ∈ {𝒜}_{t + 1} .$
  $8 {:}_{t + 1} := arg max {c}_{a} {U}_{t + 1}^{a} ( x ) - {c}_{l} {L}_{t + 1}^{l} ( x ) , where x ∈ {𝒜}_{t + 1} - {h}_{t + 1} .$
  $9 : if {c}_{a} {L}_{t + 1}^{a} ( {h}_{t + 1} ) - {c}_{l} {U}_{t + 1}^{l} ( {h}_{t + 1} ) > {c}_{a} {U}_{t + 1}^{a} ( {r}_{t + 1} ) - {c}_{l} {L}_{t + 1}^{l} ( {r}_{t + 1} ) then$
10: Stop with hₜ.
```

It can be proven that for any ε>0, the following holds with high probability, where x* is a solution to (P1):

$$\frac{1}{T} {\sum }_{t = 1}^{T} {c}_{a} {A}_{t} ( x \text{*)} - {c}_{l} {L}_{t} ( ( x \text{*)} - \frac{1}{T} {\sum }_{t = 1}^{T} {c}_{a} {A}_{t} ( {h}_{t} ) - {c}_{l} {L}_{t} ( {h}_{t} ) \leq ϵ .$$

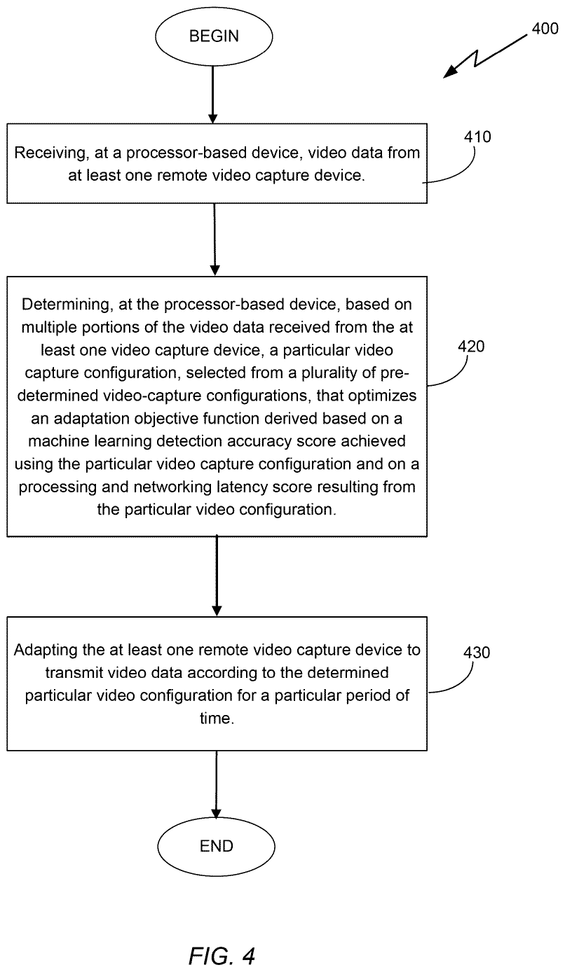

With reference next to FIG. 4, a flowchart of an example procedure 400 for real-time adaptive video analytics generation is disclosed. The procedure 400 includes receiving 410, at a processor-based device, video data from at least one remote video capture device, and determining 420, at the processor-based device, based on multiple portions of the video data received from the at least one video capture device, a particular video capture configuration, selected from a plurality of pre-determined video-capture configurations, that optimizes an adaptation objective function derived based on a machine learning detection accuracy score achieved using the particular video capture configuration and on a processing and networking latency score resulting from the particular video configuration. The procedure 400 further includes adapting 430 the at least one remote video capture device to transmit video data according to the determined particular video configuration for a particular period of time.

In various examples, the method can further include repeating the receiving, determining, and adapting for the at least one remote video capture device at regular or irregular time intervals. In some examples, each of the plurality of video capture configurations can include a different combination of video capture parameters that includes at least a video capture resolution and a video capture frame rate.

The receiving, determining, and adapting can separately be performed in sequence for a plurality of video capture devices according to a round robin schedule. In some embodiments, receiving the video data from the at least one remote video capture device can include receiving a sequence of video data sets, each of the video data sets captured by the at least one remote video capture device using at least some of the plurality of video capture configurations. Determining the particular video capture configuration that optimizes the adaptation objective function can include computing a respective latency score and ML accuracy score for a first data set in the sequence of video data sets relating the ML detection accuracy, achieved when an ML detection model is applied to the first data set, to a maximum accuracy achieved when the ML detection model is applied to a proxy video data set obtained using a designated optimal video configuration. The method may further include determining, based on the respective latency score and ML accuracy score computed for at least the first data set, a subsequent video capture configuration from the plurality of video capture configurations, and capturing a subsequent data set in the sequence of video data sets with the determined subsequent video capture configuration. Determining the subsequent video capture configuration can include applying a multi-armed bandit process to the respective latency score and ML accuracy score computed for the at least the first data set to determine the subsequent video configuration.

In various examples, determining the respective latency score may include deriving the latency score as a function of one or more of, for example, an encoding latency to encode the first data set, a network latency to transmit the first data set to the processor-based device, and/or an inference latency to generate detection data by the ML detection model executing on an ML system. In some examples, the method can further include applying the ML detection model to the proxy video data set obtained using a designated optimal video configuration. Computing the respective latency score, computing the ML accuracy score, and applying the ML detection model to the proxy video data set can be performed as asynchronous parallel computing-system tasks. In various embodiments, the procedure may further include applying the ML detection model to receive video data to perform real-time context and capability assessment for detecting warning signs and anomalies within the video data.

Implementing the proposed framework and performing the various techniques and operations described herein may be facilitated by a controller device(s) (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, efficient online adaptation processes for large-scale video analytics optimization. The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

In implementations based on learning machines, different types of learning architectures, configurations, and/or implementation approaches may be used. Examples of learning machines include neural networks, including convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc. Further examples of learning architectures that may be used to implement the framework described herein include language models architectures, large language model (LLM) learning architectures, auto-regressive learning approaches, etc. In some embodiments, encoder-only architectures, decoder-only architectures, encoder-decoder architecture, etc.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuitry, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

The various learning processes implemented through use of the machine-learning architectures described herein may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, PyTorch, JAX, and other popular machine learning frameworks.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method for real-time adaptive video analytics generation, the method comprising:
receiving, at a processor-based device, video data from at least one remote video capture device;
determining, at the processor-based device, based on multiple portions of the video data received from the at least one video capture device, a particular video capture configuration, selected from a plurality of pre-determined video-capture configurations, that optimizes an adaptation objective function derived based on a machine learning detection accuracy score achieved using the particular video capture configuration and on a processing and networking latency score resulting from the particular video configuration; and
adapting the at least one remote video capture device to transmit video data according to the determined particular video configuration for a particular period of time.

2. The method of claim 1, further comprising:
repeating the receiving, determining, and adapting for the at least one remote video capture device at regular or irregular time intervals.

3. The method of claim 1, wherein the receiving, determining, and adapting are separately performed in sequence for a plurality of video capture devices according to a round robin schedule.

4. The method of claim 1, wherein receiving the video data from the at least one remote video capture device comprises:
receiving a sequence of video data sets, each of the video data sets captured by the at least one remote video capture device using at least some of the plurality of video capture configurations.

5. The method of claim 4, wherein determining the particular video capture configuration that optimizes the adaptation objective function comprises:
computing a respective latency score and ML accuracy score for a first data set in the sequence of video data sets relating the ML detection accuracy, achieved when an ML detection model is applied to the first data set, to a maximum accuracy achieved when the ML detection model is applied to a proxy video data set obtained using a designated optimal video configuration.

6. The method of claim 5, further comprising:
determining, based on the respective latency score and ML accuracy score computed for at least the first data set, a subsequent video capture configuration from the plurality of video capture configurations; and
capturing a subsequent data set in the sequence of video data sets with the determined subsequent video capture configuration.

7. The method of claim 6, wherein determining the subsequent video capture configuration comprises:
applying a multi-armed bandit process to the respective latency score and ML accuracy score computed for the at least the first data set to determine the subsequent video configuration.

8. The method of claim 5, wherein determining the respective latency score comprises:
deriving the latency score as a function of one or more of: an encoding latency to encode the first data set, a network latency to transmit the first data set to the processor-based device, and an inference latency to generate detection data by the ML detection model executing on an ML system.

9. The method of claim 5, further comprising:
applying the ML detection model to the proxy video data set obtained using a designated optimal video configuration;
wherein computing the respective latency score, computing the ML accuracy score, and applying the ML detection model to the proxy video data set are performed as asynchronous parallel computing-system tasks.

10. The method of claim 1, wherein each of the plurality of video capture configurations comprises a different combination of video capture parameters that includes at least a video capture resolution and a video capture frame rate.

11. The method of claim 1, further comprising:
applying the ML detection model to the received video data to perform real-time context and capability assessment for detecting warning signs and anomalies within the video data.

12. A surveillance system with real-time adaptive video analytics generation, the system comprising:
at least one remote video capture device; and
at least one processor-based device in communication with the at least one remote video capture device, the at least one processor-based device configured to:
receive video data from at least one video remote capture device;
determine based on multiple portions of the video data received from the at least one remote video capture device, a particular video capture configuration, selected from a plurality of pre-determined video-capture configurations, that optimizes an adaptation objective function derived based on a machine learning detection accuracy score achieved using the particular video capture configuration and on a processing and networking latency score resulting from the particular video configuration; and
adapt the at least one remote video capture device to transmit video data according to the determined particular video configuration for a particular period of time.

13. The surveillance system of claim 12, wherein the at least one processor-based device is further configured to:
repeat the receiving, determining, and adapting for the at least one remote video capture device at regular or irregular time intervals.

14. The surveillance system of claim 12, wherein the at least one processor-based device configured to receive, determine, and adapt is configured to separately perform in sequence the receive, determine, and adapt for a plurality of video capture devices according to a round robin schedule.

15. The surveillance system of claim 12, wherein the at least one processor-based device configured to receive the video data from the at least one remote video capture device is configured to:
receive a sequence of video data sets, each of the video data sets captured by the at least one remote video capture device using at least some of the plurality of video capture configurations.

16. The surveillance system of claim 15, wherein the at least one processor-based device configured to determine the particular video capture configuration that optimizes the adaptation objective function is configured to:
compute a respective latency score and ML accuracy score for a first data set in the sequence of video data sets relating the ML detection accuracy, achieved when an ML detection model is applied to the first data set, to a maximum accuracy achieved when the ML detection model is applied to a proxy video data set obtained using a designated optimal video configuration.

17. The surveillance system of claim 16, wherein the at least one processor-based device is further configured to:
determine, based on the respective latency score and ML accuracy score computed for at least the first data set, a subsequent video capture configuration from the plurality of video capture configurations; and
capture a subsequent data set in the sequence of video data sets with the determined subsequent video capture configuration.

18. The surveillance system of claim 17, wherein the at least one processor-based device configured to determine the subsequent video capture configuration is configured:
apply a multi-armed bandit process to the respective latency score and ML accuracy score computed for the at least the first data set to determine the subsequent video configuration.

19. The surveillance system of claim 16, wherein the at least one processor-based device is further configured to:
apply the ML detection model to the proxy video data set obtained using a designated optimal video configuration;
wherein the at least one processor-based device configured to compute the respective latency score, compute the ML accuracy score, and apply the ML detection model to the proxy video is configured to perform the operations as asynchronous parallel computing-system tasks.

20. Non-transitory computer readable media comprising computer instructions executable on a processor-based device to:
receive video data from at least one remote video capture device;
determine based on multiple portions of the video data received from the at least one video capture device, a particular video capture configuration, selected from a plurality of pre-determined video-capture configurations, that optimizes an adaptation objective function derived based on a machine learning detection accuracy score achieved using the particular video capture configuration and on a processing and networking latency score resulting from the particular video configuration; and
adapt the at least one remote video capture device to transmit video data according to the determined particular video configuration for a particular period of time.
